(19) United States
(12) Patent Application Publication
(10) Pub. No.: US 2014/0226336 A1
(43) Pub. Date: Aug. 14, 2014

(54) SMART LED LIGHT DEVICE WITH LIGHT COLOR AUTOMATICALLY CHANGEABLE

(71) Applicant: THE LIGHT OF THE WORLD INTERNATIONAL CO., LTD., Kaohsiung City (TW)

(72) Inventor: Po Wen CHI, Kaohsiung City (TW)

(21) Appl. No.: 13/906,616

(22) Filed: May 31, 2013

(30) Foreign Application Priority Data
Feb. 8, 2013 (TW) 102203081

(51) Int. Cl. F21K 99/00

(52) U.S. Cl. CPC F21K 9/58
USPC 362/280

(57) ABSTRACT

A smart LED lighting device with light color automatically changeable comprises a LED lighting component, a driving motor, and a rotary light filtering member. The LED lighting component has a light emitting surface. The rotary light filtering member is connected with the driving motor. The rotary light filtering member covers the light emitting surface of the LED lighting component, and the rotary light filtering member has a plurality of filtering color portions arranged on a rotation path facing toward the light emitting surface. Thereby the color of the light from the light source is changeable to be more applicable in the situation of environment change and to be more suitable for the requirement of use, and thus the smart LED lighting device of the present invention provides an appropriate lighting effect and can be applied broadly.

### CROSS REFERENCE TO RELATED APPLICATION

This application claims priority to Taiwanese Patent Application No. 102203081, filed Feb. 8, 2013, which is hereby incorporated by reference.

### FIELD OF THE INVENTION

The present invention relates to a LED lighting device, and more particularly to a smart LED lighting device with light color automatically changeable.

### BACKGROUND OF THE INVENTION

In recent years, for the purpose of environmental protection, light emitting diodes (LEDs) are widely applied in a field of lighting device for advantages in energy saving and carbon reduce. LEDs have other advantages including higher efficiency, less volume, less weight, longer operating life. With replacement of incandescent light bulbs, the LEDs are thus gradually applied in the lighting devices, such as street lamps, car lamps, indoor lightings. However, as a street lamp for example, for different situations of whether, such as a sunny day, a rainy day, or a foggy day, it sometimes requires the lights of the street lamp with different characteristics of light penetration and of various colors so as to provide proper illumination. Moreover, as a indoor light for another example, it requires to adjust the light color of the indoor light to change the color tones of indoor space for personal feelings.

The LEDs are manufactured with a color not changeable. Therefore if LEDs with changeable color are desired, there should have one lighting device allocated with many different colors. A user thus lights up different set of colors of LEDs to obtain different colors.

However, with the increasing color of LEDs, in order to maintain the brightness degree, it is inevitable to have a LED device with an increasing size. Therefore, the structure of the lighting device becomes more complicated, and the cost of LEDs will increase at the same time. Moreover, the circuit of the lighting device also becomes complicated and is difficult for being controlled.

### SUMMARY OF THE INVENTION

Therefore, an object of the present invention is to provide a smart LED lighting device with light color automatically changeable, and the structure thereof is simple, low cost and easy for control, to overcome the problems above.

According to the present invention, the smart LED lighting device with automatically changeable light color comprises a LED lighting component, a driving motor, and a rotary light filtering member. The LED lighting component has a light emitting surface. The rotary light filtering member connected with the driving motor, the rotary light filtering member covering the light emitting surface of the LED lighting component, the rotary light filtering member having a plurality of filtering color portions arranged on a rotation path facing toward the light emitting surface.

According to the present invention, an axial direction of the rotary light filtering member is perpendicular to the light emitting surface.

According to the present invention, the LED lighting component includes a plurality of LEDs.

According to the present invention, the LED lighting component is an integrated circuit of LED.

According to the present invention, further comprising a reflective plate surrounding the LED lighting component.

According to the present invention, a central opening is formed in the center of the reflective plate, and the central opening faces toward the light emitting surface of the LED lighting component.

According to the present invention, further comprising a control member connected with the driving motor.

According to the present invention, further comprising a brightness sensing member connected with the control member.

In the present invention, the color of the LED lighting devices is adjustable according to different situations or environment statuses. The LED light device thus may only need a single set of LEDs to perform various different colors and still maintain the effect of full brightness. The LED lighting devices has further advantages including simple structure, low cost, and simple control of circuit. Moreover, during the colors is being changed, it is not required to switch any LED, so the power impact in the switch is reduced. And thus the LED lighting device can has the longer operating life and can maintain stable performance.

### BRIEF DESCRIPTION OF THE DRAWINGS

The structure and the technical means applied by the present invention for achieving the above and other objects can be best understood by referring to the following detailed description of the preferred embodiments and the accompanying drawings.

FIG. 1 is a stereogram illustrating smart LED lighting device with light color automatically changeable according to one embodiment of the present invention.

FIG. 2 is a explosion diagram illustrating smart LED lighting device with light color automatically changeable according to one embodiment of the present invention.

FIG. 3 is a sectional view illustrating smart LED lighting device with light color automatically changeable according to one embodiment of the present invention.

FIG. 4 is a top view illustrating smart LED lighting device with automatically light color changeable according to one embodiment of the present invention.

### DETAILED DESCRIPTION OF THE PREFERRED EMBODIMENTS

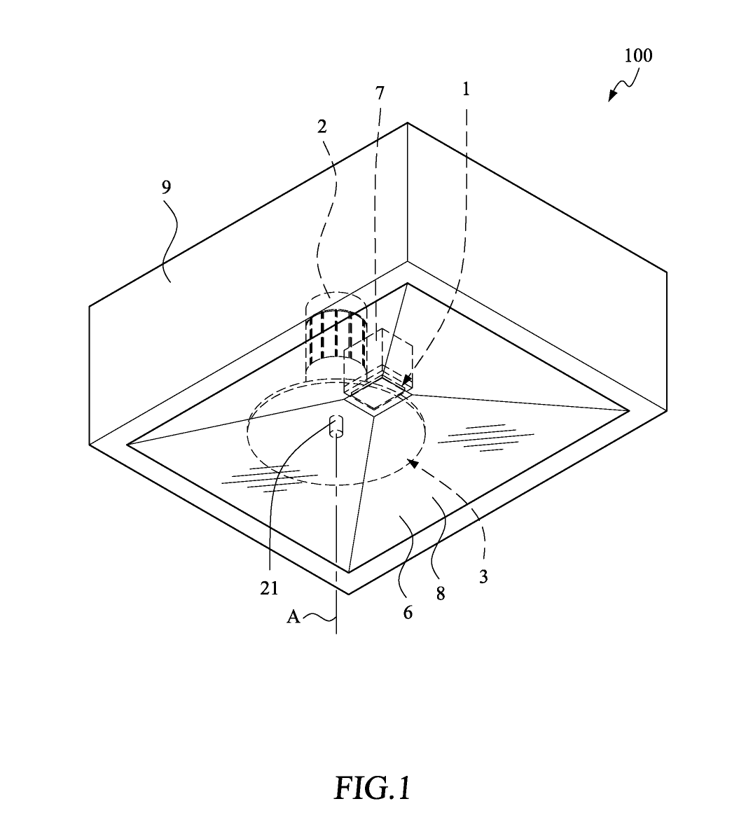

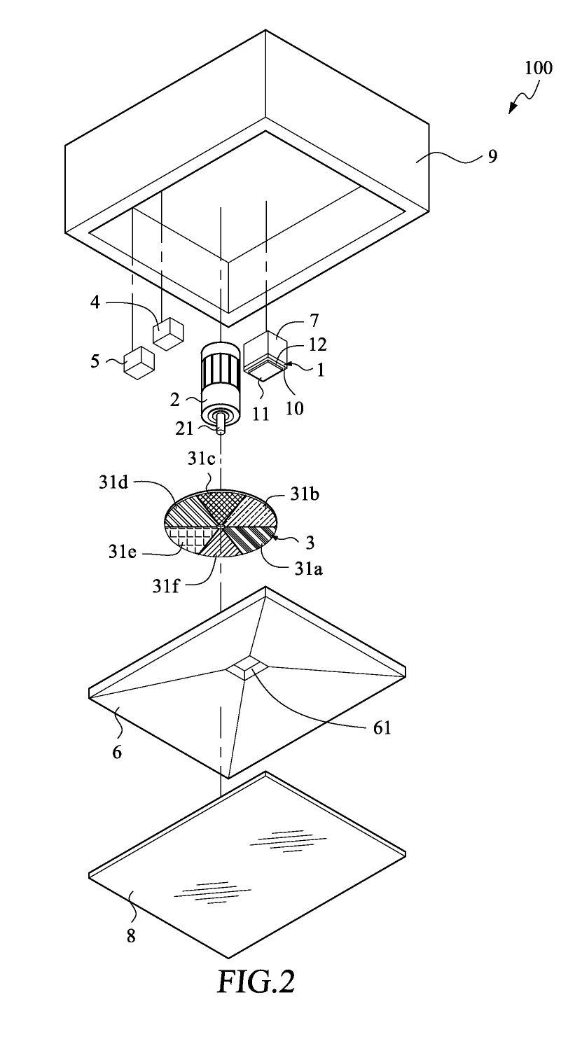

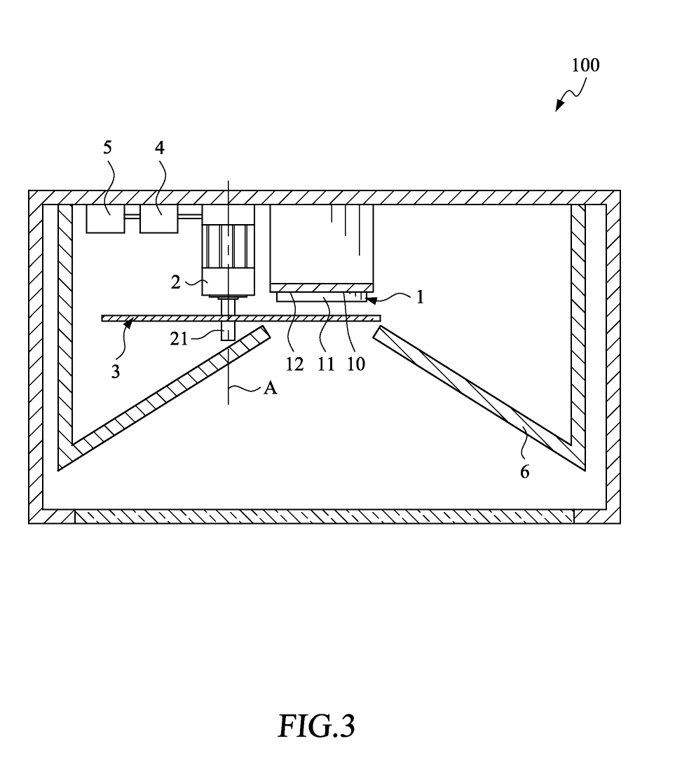

Please refer to FIG. 1 to FIG. 4. A smart LED lighting device with light color automatically changeable 100 according to this embodiment includes a LED lighting component 1, a driving motor 2, and a rotary light filtering member 3.

The LED lighting component 1 may include only one LED or a plurality of LEDs. In this embodiment, the LED lighting component 1 includes an integrated circuit of LED 10. The integrated circuit of LED 10 is disposed on a circuit board 12 to form a light emitting surface 11 for illuminating light. The integrated circuit of LED 10 is a high power element whose Watt in the range from 5 to 200, and is with luminous flux over 10000 lumens. Furthermore, the LED lighting component 1 is manufactured by using technology of integrated chip packaging with advantage of small size, low voltage, concentrated light source, long operating life, energy-efficiency, and environment protection. Besides, the LED lighting component 1 is further combined with a heat dissipating substrate 7. The heat dissipating substrate 7 can help the LED lighting component 1 to dissipate heat to elongate the product life of the LED lighting component 1. The heat dissipating substrate 7 is disposed at the bottom of a shell 9 and is located within an interior space of the shell 9.

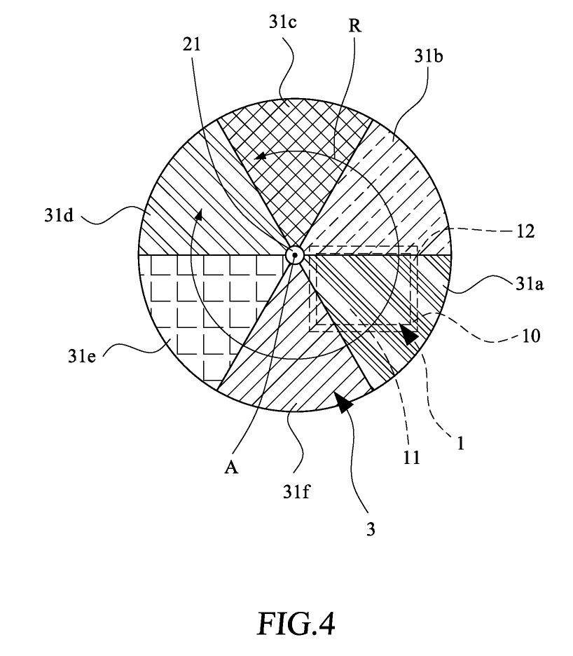

The driving motor 2 has a rotary driving shaft 21, and the driving motor 2 is disposed at the bottom of the shell 9 and is located within the inner space of the shell 9. The rotary light filtering member 3 is connected with the rotary driving shaft 21 and thus is rotated by the driving motor 2. The rotary light filtering member 3 covers and faces the light emitting surface 11 of the LED lighting component 1. As shown in FIG. 4, the rotary light filtering member 3 has a plurality of filtering color portions 31a˜31f. The filtering color portions 31a˜31f are arranged on a rotation path R facing toward the light emitting surface 11. In FIG. 4, an axial direction A of the rotary light filtering member 3 is provided at the center of the rotary light filtering member 3. The rotation path R is formed as the rotary light filtering member 3 is rotated around the axial direction A. Preferably, the axial direction A of the rotary light filtering member 3 is perpendicular to the light emitting surface 11. The light from the light emitting surface 11 can pass through a plurality of the filtering color portions 31a˜31f without being refracted by the filtering color portions 31a˜31f when the relative facing angle between the filtering color portions 31a˜31f and the light emitting surface 11 is existed. A lamp cover 8 is provided at an opening of the shell 9 and is facing toward the light emitting surface 11 to cover the light emitting surface 11.

The smart LED lighting device with light color automatically changeable 100 further includes a control member 4. The control member 4 is disposed at the bottom of the shell 9 and is located within the inner space of the shell 9. The control member 4 is connected with the driving motor 2. In this embodiment, the control member 4 can receive an external message to control the action of the driving motor 2.

Moreover, in this embodiment, the smart LED lighting device with light color automatically changeable 100 further includes a brightness sensing member 5. The brightness sensing member 5 is electrically connected with the control member 4. The brightness sensing member 5 can sense the change of brightness according to different environment statuses, such as night, dusk, daytime, rainy day, foggy day, and so on. The brightness sensing member 5 can transfer signals of the sensed brightness to the control member 4. The driving motor 2 can be switched by the control member 4 to make the rotary driving shaft 21 to drive the rotary light filtering member 3.

Furthermore, the colors of the filtering color portions 31a˜31f may choose from a group comprising, as an example, colors of orange, red, yellow, green, blue, purple, transparency. The light color of the light that passes through the filtering color portions 31a˜31f is different from that of the light source. While the brightness sensing member 5 is operated to detect that the brightness of the environment is of high degree of brightness, as an example in a daytime, the transparency portion of the filtering color portions 31a˜31f is selected to face toward the light emitting surface by rotating the filtering color portions 31˜a31f, or by turning off the LED lighting component 1. While the brightness sensing member 5 is operated to detect that the environment brightness is of low degree of brightness, as an example in the dusk, the night, or the foggy, the rotary driving shaft 21 of the driving motor 2 is rotated to set the rotary light filtering member 3 in a presetting position where the color of light passing through the filtering color portions 31a˜31f is desired, by the control member 4

The smart LED lighting device with light color automatically changeable 100 further includes a reflective plate 6. The reflective plate 6 surrounds the LED lighting component 1. A central opening 61 is formed in the center of the reflective plate 6. The central opening 61 faces toward the light emitting surface 11 of the LED lighting component 1. The lights from the light emitting surface 11 can pass through plurality of the filtering color portions 31a˜31f and then pass through the central opening 61. The lights passing through the central opening 61 can be reflected by the reflective plate 6 so as to concentrate the lights from the light emitting surface 11 and to enhance the brightness of the lights.

Furthermore, the smart LED lighting device with light color automatically changeable also can be applied on street lights, garden lights, tunnel lights, spot lights, mining lamps, car lamps, flashlights and so on.

The above description should be considered as only the discussion of the preferred embodiments of the present invention. However, a person skilled in the art may make various modifications to the present invention. Those modifications still fall within the spirit and scope defined by the appended claims.

What is claimed is:

1. A smart LED lighting device with light color automatically changeable, comprising:
a LED lighting component having a light emitting surface;
a driving motor; and
a rotary light filtering member connected with the driving motor, the rotary light filtering member covering the light emitting surface of the LED lighting component, the rotary light filtering member having a plurality of filtering color portions arranged on a rotation path facing toward the light emitting surface.

2. The smart LED lighting device with light color automatically changeable as claimed in claim 1, wherein an axial direction of the rotary light filtering member is perpendicular to the light emitting surface.

3. The smart LED lighting device with light color automatically changeable as claimed in claim 1, wherein the LED lighting component includes a plurality of LEDs.

4. The smart LED lighting device with light color automatically changeable as claimed in claim 1, wherein the LED lighting component is an integrated circuit of LED.

5. The smart LED lighting device with light color automatically changeable as claimed in claim 1, further comprising a reflective plate surrounding the LED lighting component.

6. The smart LED lighting device with light color automatically changeable as claimed in claim 5, wherein a central opening is formed in the center of the reflective plate, and the central opening faces toward the light emitting surface of the LED lighting component.

7. The smart LED lighting device with light color automatically changeable as claimed in claim 1, further comprising a control member connected with the driving motor.

8. The smart LED lighting device with light color automatically changeable as claimed in claim 1, further comprising a brightness sensing member connected with the control member.
